(19) United States
(12) Patent Application Publication
(10) Pub. No.: US 2001/0023204 A1
(43) Pub. Date: Sep. 20, 2001

(54) Recording medium, computer, method for executing processes thereon, and method of selecting and executing processes on the computer

(76) Inventor: Nobuhiro Komata, Tokyo (JP)

Correspondence Address: HELFGOTT & KARAS, P.C., 60th Floor, Empire State Building, New York, NY, 10118-0110, US

(21) Appl. No.: 09/757,816

(22) Filed: Jan. 10, 2001

(30) Foreign Application Priority Data
Jan. 14, 2000 (JP) 2000-40262

(51) Int. Cl. G06F 19/00

(52) U.S. Cl. 463/37

(57) ABSTRACT

The pushing of a simple ON/OFF switch or the continuous pushing thereof for an output representation is made an easier-to-use interface for users of a controller connectable to an entertainment system. The recording medium has a program that performs processing based on instructions depending on the duration of pushing of the controller by the user. Alternately, the program performs processing based on instructions depending on the magnitude of the output value of the controller. Moreover, the computer is provided with means of determining the duration of the pressure sensed by the pressure-sensitive unit of the controller, means of selecting and entering an instruction corresponding to the duration of pressure by the user, and means of executing a process based on the instruction entered.

### FIELD OF THE INVENTION

The present invention relates to a recording medium, a computer, a method of executing processes on the computer and a method of selecting and executing on the computer processes for making the pushing of a simple ON/OFF switch or a continuous pushing of that switch for an output representation an easier-to-use interface for users.

### BACKGROUND OF THE INVENTION

In a computer or entertainment system, at the time of execution of a game program or business software program, a controller, a keyboard, a pointing device or another input device are used for various types of control or for giving instructions to the user. The switches mounted upon these input devices are typically ON/OFF switches or rotary switches. All of such ON/OFF switches, rotary switches and the like essentially give directions to a game or the business software running on a computer by turning the switch ON or continuing the switch to be held ON by the user.

For example, a pressure-sensitive type controller was disclosed in the publication of examined Japanese utility model application No. JP-B-H1-40545, wherein pressure-sensitive output is provided as an input to a VCO (variable control oscillator) and the output of the VCO is used for repeated fire in a game.

In addition, fighting games are disclosed in the publications of unexamined Japanese patent applications JP-A-H7-239949 and JP-A-H7-244545.

### SUMMARY OF THE INVENTION

It is an object of the present invention to make the pushing of a simple ON/OFF switch or the continuous pushing of that switch by the user for an output representation an easier-to-use interface for users.

The above and other objects of the present invention are attained by a recording medium on which is recorded a computer-readable and executable program that performs processing by taking as instructions the output from a controller which includes pressure-sensitive means, wherein said software program performs processing based on instructions depending on the duration of pushing of the controller by a user.

In an embodiment of the present invention the software program of the recording medium on which is recorded a computer-readable and executable program that performs processing by taking as instructions the output from the controller which has pressure-sensitive means, performs processing based on instructions depending on the magnitude of the output value of the controller.

The objects of the present invention are also attained by a computer comprising a controller which has pressure-sensitive means; means for determining the duration of pressure sensed by the pressure-sensitive means; means for selecting and entering an instruction corresponding to the duration of pressure; and means for executing a process based on the instruction thus entered.

In an embodiment, a computer comprising a controller which has pressure-sensitive means, further comprises: means for determining a magnitude of the pressure sensed by the pressure-sensitive means; means for selecting and entering an instruction corresponding to the magnitude of pressure; and means for executing a process based on the instruction thus entered.

Furthermore, a computer comprising a controller which has pressure-sensitive means, may comprise: means for determining a percent change between a pressure value sensed previously by said pressure-sensitive means and the current pressure value; means for selecting and entering an instruction corresponding to said percent change in the pressure value; and means for executing a process based on said instruction thus entered.

According to the present invention, a method of executing processes using a computer including a controller which has pressure-sensitive means is provided, said method of executing processes comprising a step of determining the duration of the pushing pressure on said controller; a step of selecting and entering an instruction corresponding to said duration of pressure; and a step of executing a process based on said instruction thus entered.

In an embodiment, a method of executing processes using a computer including a controller which has pressure-sensitive means, comprises: a step of determining the magnitude of the pushing pressure of said controller, a step of selecting and entering an instruction corresponding to said magnitude of pressure; and a step of executing a process based on said instruction thus entered.

According to yet another embodiment of the present invention a method of executing processes is provided, which uses a computer having a controller which has pressure-sensitive means and comprises: a step of determining the percent change between the pushing pressure value of the controller sensed previously by said pressure-sensitive means and the current pressure value, a step of selecting and entering an instruction corresponding to said percent change in said pushing pressure, and a step of executing a process based on said instruction thus entered.

### BRIEF DESCRIPTION OF THE DRAWINGS

FIG. 1 is a schematic diagram of an example of connecting an entertainment system to a TV monitor;

FIGS. 2A and 2B diagrammatically show the state of a player selecting whether or not the player character will fight with an enemy character;

FIGS. 3A and 3B diagrammatically show the state wherein three commands are displayed on the monitor;

FIG. 4 diagrammatically shows a table for selecting commands depending on the pushing time of a pressure-sensitive button by a user;

FIG. 5 is a flowchart showing the processing of a program used for command selection;

FIG. 6 is a perspective view of the controller connected to the entertainment system;

FIG. 7 is a block diagram of the entertainment system;

FIG. 8 is a top view of the controller;

FIG. 9 is an exploded perspective view of an embodiment of a second control part of the controller;

FIGS. 10A-10C show a cross section of the second control part of FIG. 9;

FIG. 11 diagrammatically shows an equivalent circuit for a pressure-sensitive device;

FIG. 12 is a block diagram of the main parts of the controller;

FIG. 13 is an exploded perspective view showing an embodiment of the first control part of the controller;

FIG. 14 is a cross sectional view of the first control part of the controller of FIG. 13;

FIG. 15 is a diagram showing the circuit configuration of a resistor;

FIG. 16 is a graph showing the characteristic of the signal output;

FIG. 17 is a block diagram of the overall configuration including the resistor; and

FIG. 18 is an exploded perspective view showing an embodiment of the third control part of the controller.

### DESCRIPTION OF THE PREFERRED EMBODIMENT

In the present invention, commands which depend on the pushing time of a pressure-sensitive button of a controller 200 by a user are given to an entertainment system 500. Thereby, it is possible to provide a system with a user interface that is improved in comparison with the repeated or continuous turning ON of a simple ON/OFF switch.

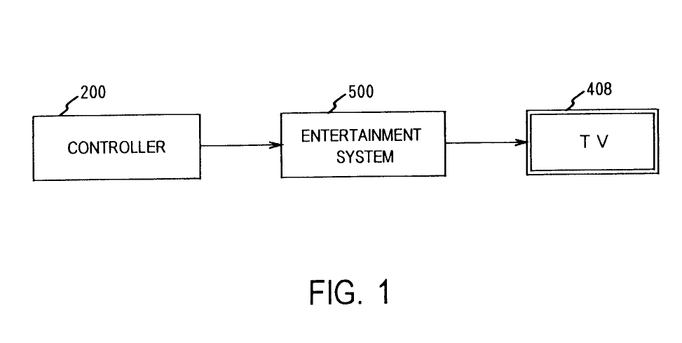

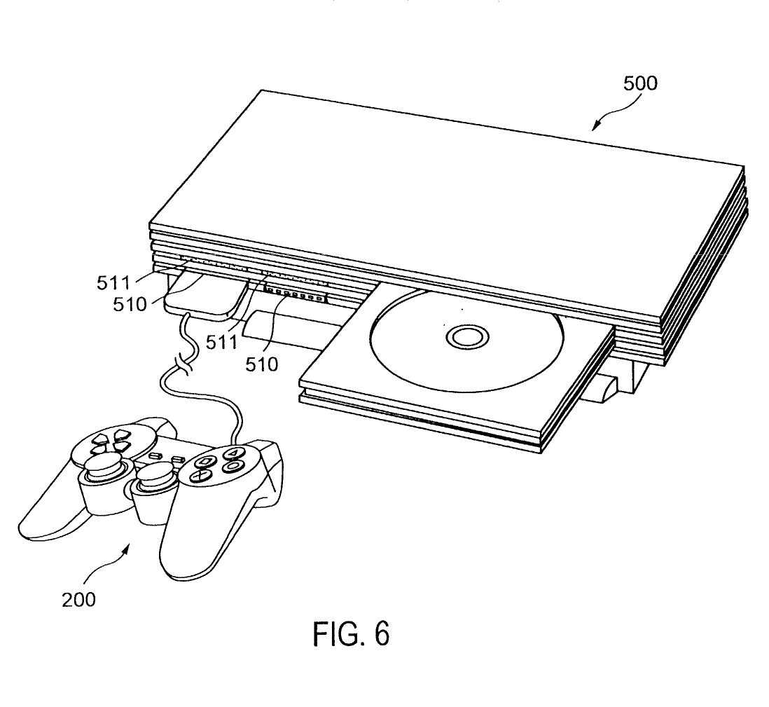

FIG. 1 is a schematic diagram showing an example of connecting an entertainment system 500 to a TV monitor 408 to enable players to enjoy a game software or a video. More specific structure is shown in FIGS. 6-18.

As shown in FIG. 1, controller 200 which has buttons connected to the pressure-sensitive devices thereof (as will be described below) is connected to the entertainment system 500 used for playing games or enjoying a DVD video or other types of video images, and the video output terminals are connected to the television monitor 408. Here, the analog output from the pressure-sensitive devices is converted by an A/D converter to digital values in the range 0-255 and provided to the entertainment system 500.

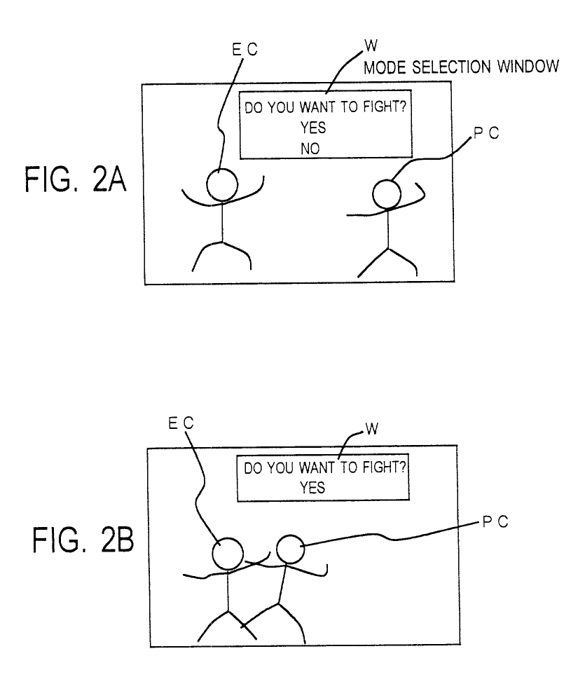

With reference to FIGS. 2-5, the case is shown of giving commands which depend on the pushing time of the pressure-sensitive button of controller 200 by a user.

FIGS. 2A-2B show a situation in a certain game wherein the player makes a selection as to whether or not the player character PC, which the player controls, will fight against the enemy character EC.

As shown in FIG. 2A, when the player makes a selection in response to the question “Do you want to fight?”displayed in a mode selection window W, the pressure-sensitive button may be pushed for a short length of time (e.g., 1-2 seconds of time) to select “YES” or pushed for a long length of time (e.g., 3-5 seconds of time) to select “NO.” For example, if the player hits the pressure-sensitive button, namely pushing it for an extremely short length of time (e.g., 0.5-1 second of time) then “YES” or namely, fight with the enemy character EC, will be selected. In this case, the player character PC and the enemy character EC will begin to fight as shown in FIG. 2B.

In this manner, a command that depends on the pushing time of the pressure-sensitive button will be given to the entertainment system 500.

In addition, it is also possible to give to the entertainment system 500 a command that depends not on the pushing time of the pressure-sensitive button, but on the magnitude of the pushing pressure. For example, in the example of FIG. 2, the pressure-sensitive button may be pushed strongly (e.g., with a strength of 200 or greater among a range of 256 steps) to select “YES” or pushed weakly (e.g., with a strength of 100 or less among a range of 256 steps) to select “NO.”

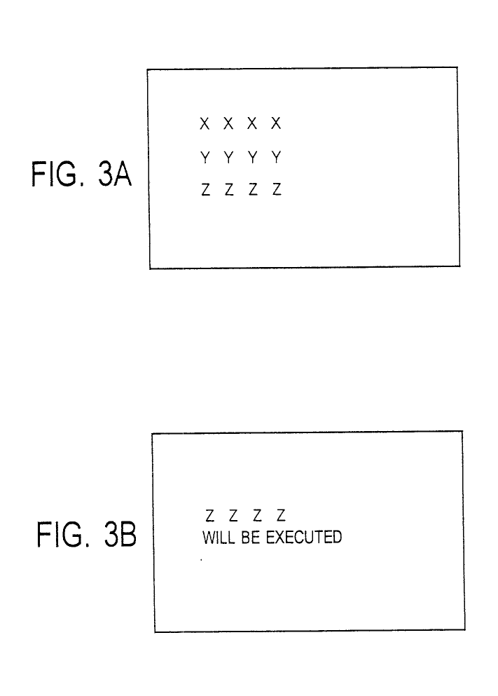

In addition, FIGS. 3A-3B show the state wherein three commands that the user can give to the entertainment system 500 are displayed on the television monitor 408. In this case, in order to select the desired command from among the three commands, it is necessary to have three different lengths of pushing time.

Specifically, different lengths of pushing times of the pressure-sensitive button correspond to each of the commands XXXX, YYYY and ZZZZ. For example, when the pressure-sensitive button is hit (the case wherein the pushing time is the shortest) then command XXXX is selected and executed. When the pressure-sensitive button is pushed and held down for 2 seconds or longer, for example, (the case wherein the pushing time is average) then command YYYY is selected and executed. When the pressure-sensitive button is pushed and held down for 4 seconds or longer, for example, (the case wherein the pushing time is the longest) then command ZZZZ is selected and executed.

This embodiment represents an example wherein a plurality of commands may be selected depending on the length of the pushing time of the pressure-sensitive button, but it is also possible to select from among a plurality of commands depending on the magnitude of the pushing force on the pressure-sensitive button.

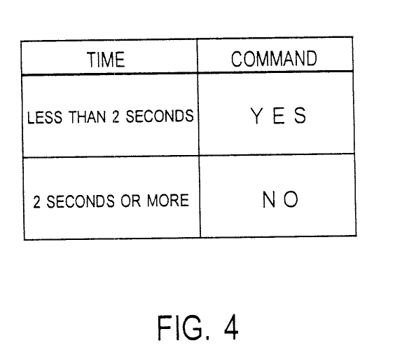

FIG. 4 shows a table corresponding to the example shown in FIG. 2 for the case wherein pushing the pressure-sensitive button for less than 1 second corresponds to “YES” and pushing for 2 seconds or longer corresponds to “NO,” or namely a table for selecting various commands depending on the pushing time of the pressure-sensitive button.

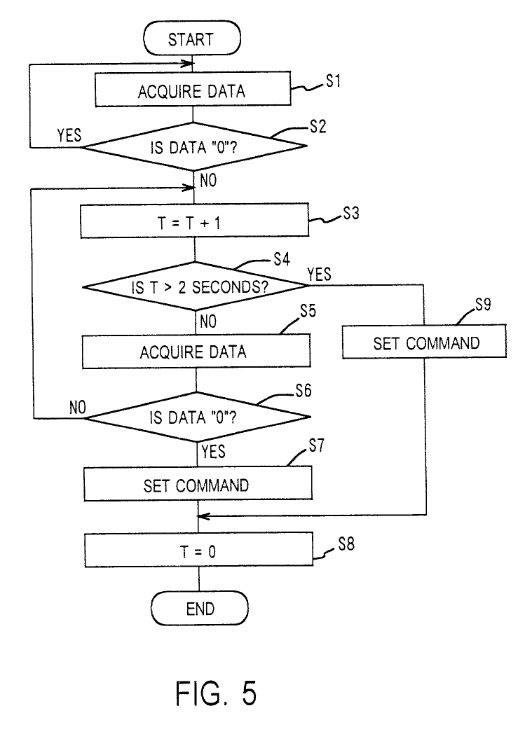

Next, with reference to FIG. 5, the method of selecting commands, will be described, depending on the pushing time of a pressure-sensitive button. In order to simplify the description, the examples illustrated in FIGS. 2A-2B and FIG. 4 will be described.

The flowchart shown in FIG. 5 illustrates the processing of a program used for command selection, and this program may be supplied either recorded alone upon an optical disc or other recording medium, or recorded upon said recording medium together with the game software as part of the game software.

This program is run by the entertainment system 500 and executed by its CPU. The meaning of supplying these programs recorded individualy on a recording medium has the meaning of preparing them in advance as a library for software development. As is common knowledge, at the time of developing software, writing all functions requires an enormous amount of time.

However, if the software functions are divided into different types of functions, for example, objects can be moved and otherwise used commonly by various types of software, so more functions can be included.

To this end, a function such as that described in this preferred embodiment that can be used commonly may be provided to the software manufacturer side as a library program. When general functions like this are supplied as external programs in this manner, it is sufficient for the software manufacturers to write only the essential portions of the software.

In Step S1, a pressure-sensed value is acquired from the controller 200, and in Step S2 a decision is made as to whether the value thus acquired is 0 or not, and if “YES” then control processing moves back to Step S1, but if “NO” then control moves to Step S3.

In Step S3, the time value T is incremented by 1.

In Step S4, a decision is made as to whether the time value T is greater than 2 seconds or not, and if “YES” then control procedure moves to Step S9.

In Step S9, the command is selected corresponding to greater than 2 seconds, namely “NO” which means “Do not fight” in the example in FIG. 2 and FIG. 4.

On the other hand, if the result is “NO” in Step S4 then control processing moves to Step S5 where a pressure-sensed value is acquired from the controller 200.

In Step S6, a decision is made as to whether the pressure-sensed value acquired in Step S5 is 0 or not, and if “YES” then control moves to Step S7, but if “NO” then control processing moves back to Step S3.

In Step S7, a command is set and in Step S8 the time value T is set to “0” and initialized.

If in Step S4 the time value T does not exceed 2 seconds, then in Step S5 a pressure-sense value is acquired from the controller 200, and if this is determined to be “0” in Step S6, then even though it does not exceed 2 seconds, the pressure-sensed value is “0” or namely less than 1 second, the command “YES” shown in FIG. 2 is selected. Then, as shown in FIG. 4, “Fight” is selected and the fighting begins.

As described above, in this embodiment, a command is selected depending on the pushing time of a pressure-sensitive button, so it is possible to provide a system with a user interface that is improved in comparison with the selection with a simple ON/OFF switch.

Note that while the aforementioned example was described regarding the case wherein the command is selected depending on the pushing time of a pressure-sensitive button, the command may also be selected depending on the magnitude of the pressure-sense value.

In addition, the subject of selection is not limited to commands. For example, an icon or mail address or the like may also be selected depending on the pressure-sense value. By specifying a certain icon, it is possible to select a program, command, file or the like associated with that icon. In addition, by specifying a mail address, it is possible to select a specific home page on the World Wide Web on the Internet or the like associated with that mail address.

Icons, mail addresses or the like may be specified by using the pressure-sensitive controller to specify icons, mail addresses or the like appearing in order on the monitor, or by using the pressure-sensitive controller to specify icons, mail addresses or the like that are highlighted in order on the monitor.

In addition, it is also possible to find the percent change from the previous pressure-sense value to the current pressure-sense value and select a command depending on this percent change. For example, if the previous pressure-sense value is 100 and the current pressure-sense value is 50, then the percent change is 50%, so it is possible to select a command depending on this percent change.

While a working example was described above, the present invention may also assume the following alternative example. In the working example, the pressure-sensed value as pushed by the user is used as is. However, in order to correct for differences in the body weights of users or differences in how good their reflexes are, it is possible to correct the maximum value of the user pressure-sensed value to the maximum game pressure-sensed value set by the program, and intermediate values may be corrected proportionally and used. This type of correction is performed by preparing a correction table.

In addition, the user pressure-sensed value can be corrected based upon a known function, such as a higher-order function, trigonometric function or logarithmic function, and used as the game pressure-sense value. This type of correction is also performed by preparing a correction table in advance.

Moreover, the maximum value of the user pressure-sense value rate of change may be corrected to the maximum game pressure-sense value rate of change set in the program, and intermediate values can be proportionally corrected and used.

The aforementioned correction tables are stored in ROM or a memory card. User pressure-sensed values are corrected using these correction tables and used as the game pressure-sense values of game software or other programs. For more details about this method, refer to the present inventors' Japanese patent application No. 2000-40257 and the corresponding PCT application JP ______ (applicant's file reference SC00097WO00).

FIG. 6 is a diagram showing the controller 200 connected to entertainment system 500. The controller 200 is removably connected to the entertainment system 500, and the entertainment system 500 is connected to television monitor 408.

The entertainment system 500 reads the program for a computer game from recording media upon which that program is recorded and by executing the program, displays characters on the television monitor 408. The entertainment system 500 has various built-in functions for DVD (Digital Versatile Disc) playback, CDDA (compact disc digital audio) playback and the like. The signals from the controller 200 are also processed as one of the aforementioned control functions within the entertainment system 500, and the content thereof may be reflected in the movement of characters and the like, on the television monitor 408.

While this depends also on the content of the computer game program, controller 200 may be allocated functions for moving the characters display on the television monitor 408 in the directions up, down, left or right.

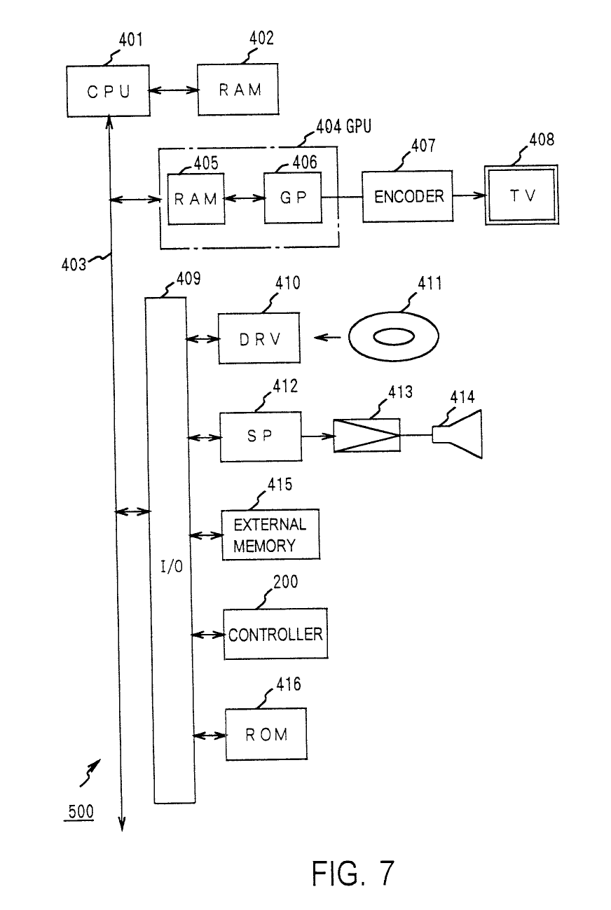

With reference to FIG. 7, here follows a description of the interior of the entertainment system 500 shown in FIG. 6. FIG. 7 is a block diagram of the entertainment system 500.

A CPU 401 is connected to RAM 402 and a bus 403, respectively. Connected to bus 403 are a graphics processor unit (GPU) 404 and an input/output processor (I/O) 409, respectively. The GPU 404 is connected via an encoder 407 for converting a digital RGB signal or the like into the NTSC standard television format, for example, to a television monitor (TV) 408 as a peripheral. Connected to the I/O 409 are a driver (DRV) 410 used for the playback and decoding of data recorded upon an optical disc 411, a sound processor (SP) 412, an external memory 415 consisting of flash memory, controller 200 and a ROM 416 which records the operating system and the like. The SP 412 is connected via an amplifier 413 to a speaker 414 as a peripheral.

Here, the external memory 415 may be a card-type memory consisting of a CPU or a gate array and flash memory, which is removably connected via a connector 511 to the entertainment system 500 shown in FIG. 6. The controller 200 is configured such that, when a plurality of buttons provided thereupon are pushed, it gives instructions to the entertainment system 500. In addition, the driver 410 is provided with a decoder for decoding images encoded based upon the MPEG standard.

The description will be made now as to how the images will be displayed on the television monitor 408 based on the operation of controller 200. It is assumed that data for objects consisting of polygon vertex data, texture data and the like recorded on the optical disc 411 is read by the driver 410 and stored in the RAM 402 of the CPU 401.

When instructions from the player via controller 200 are provided as an input to the entertainment system 500, the CPU 401 calculates the three-dimensional position and orientation of objects with respect to the point of view based on these instructions. Thereby, the polygon vertex data for objects defined by X, Y, Z coordinate values are modified variously. The modified polygon vertex data is subjected to perspective transformation processing and converted into two-dimensional coordinate data.

The regions specified by two-dimensional coordinates are so-called polygons. The converted coordinate data, Z data and texture data are supplied to the GPU 404. Based on this converted coordinate data, Z data and texture data, the GPU 404 performs the drawing process by writing texture data sequentially into the Ram 405. One frame of image data upon which the drawing process is completed, is encoded by the encoder 407 and then supplied to the television monitor 408 and displayed on its screen as an image.

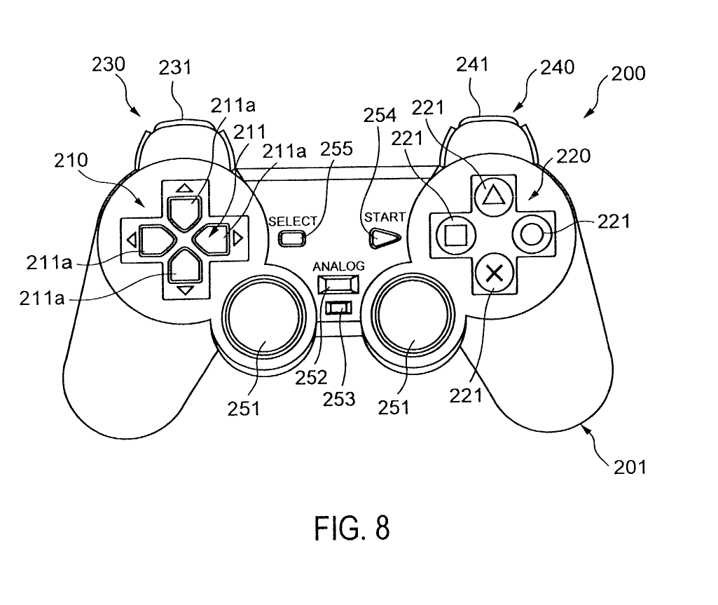

FIG. 8 is a top view of controller 200. The controller 200 consists of a unit body 201 on the top surface of which are provided first and second control parts 210 and 220, and on the side surface of which are provided third and fourth control parts 230 and 240 of the controller 200.

The first control part 210 of the controller is provided with a cruciform control unit 211 used for pushing control, and the individual control keys 211 a extending in each of the four directions of the control unit 211 form a control element. The first control part 210 is the control part for providing movement to the characters displayed on the screen of the television receiver, and has the functions for moving the characters in the up, down, left and right directions by pressing the individual control keys 211a of the cruciform control unit 211.

The second control part 220 is provided with four cylindrical control buttons 221 (control elements) for pushing control. The individual control buttons 221 have identifying marks such as “◯” (circle), “×” (cross), “Δ” (triangle), and “□” (quadrangle) on their tops, in roder to easily identify the individual control buttons 221. The functions of the second control part 220 are set by the game program recorded upon the optical disc 411, and the individual control buttons 221 may be allocated functions that change the state of the game characters, for example. For example, the control buttons 221 may be allocated functions for moving the left arm, right arm, left leg and right leg of the character.

The third and fourth control parts 230 and 240 of the controller have nearly the same structure, and both are provided with two control buttons 231 and 241 (control elements) for pushing control, arranged above and below. The functions of these third and fourth control parts 230 and 240 are also set by the game program recorded upon the optical disc, and may be allocated functions for making the game characters do special actions, for example.

Moreover, two joy sticks 251 for performing analog operation are provided upon the unit body 201 shown in FIG. 8. The joy sticks 251 can be switched and used instead of the first and second control parts 210 and 220 described above. This switching is performed by means of an analog selection switch 252 provided upon the unit body 201. When the joy sticks 251 are selected, a display lamp 253 provided on the unit body 201 lights, indicating the state wherein the joy sticks 251 are selected.

It is to be noted that on unit body 201 there are also provided a start switch 254 for starting the game and a select switch 255 for selecting the degree of difficulty or the like at the start of a game, and the like. The controller 200 is held by the left hand and the right hand and is operated by the other fingers, and in particular the thumbs of the user are able to operate most of the buttons on the top surface.

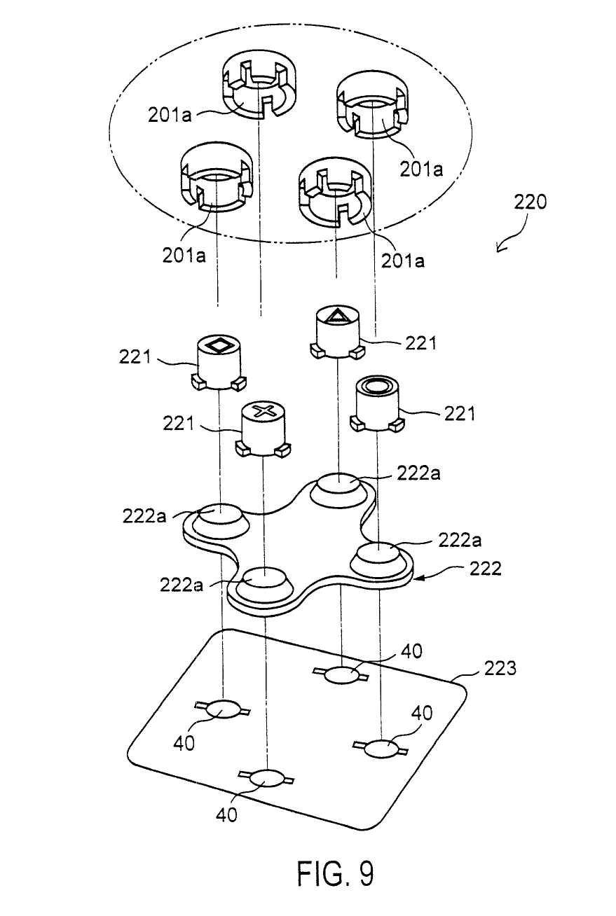

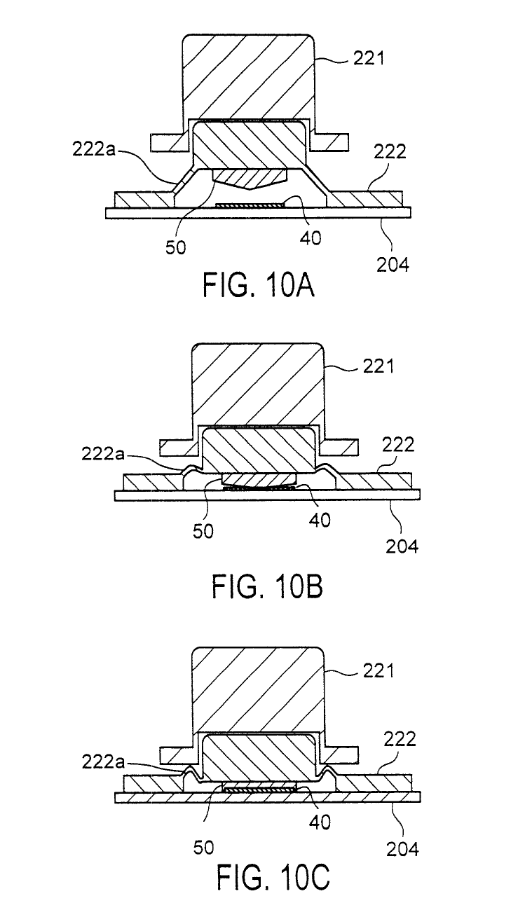

FIG. 9 and FIGS. 10A-10C are, respectively, an exploded respective view and cross-sectional views showing the second control part of the controller.

As shown in FIG. 9, the second control part 220 consists of four control buttons 221 which serve as the control elements, an elastic body 222, and a sheet member 223 provided with resistors 40. The individual control buttons 221 are inserted from behind through insertion holes 201 a formed on the upper surface of the unit body 201. The control buttons 221 inserted into the insertion holes 201a are able to move freely in the axial direction.

The elastic body 222 is made of insulating rubber or the like and has elastic areas 222a which protrude upward, and the lower ends of the control buttons 221 are supported upon the upper walls of the elastic areas 222a. When the control buttons 221 are pressed, the inclined-surface portions of these elastic areas 222a flex so that the upper walls move together with the control buttons 221. On the other hand, when the pushing pressure on the control buttons 221 is released, the flexed inclined-surface portions of elastic areas 222a elastically return to their original shape, pushing up the control buttons 221. The elastic body 222 functions as a spring means whereby control buttons 221 which had been pushed in by a pushing action are returned to their original positions. As shown in FIGS. 10A-10C, conducting members 50 are attached to the rear surface of the elastic body 222.

The sheet member 223 consists of a membrane or other thin sheet material which has flexibility and insulating properties. Resistors 40 are provided in appropriate locations on this sheet member 223 and these resistors 40 and conducting member 50 are each disposed such that they face one of the control buttons 221 via the elastic body 222. The resistors 40 and conducting members 50 form pressure-sensitive devices. These pressure-sensitive devices consisting of resistors 40 and conducting members 50 have resistance values that vary depending on the pushing pressure received form the control buttons 221.

To describe this in more detail, as shown in FIGS. 10A-10C, the second control part 220 is provided with control buttons 221 as control elements, an elastic body 222, conducting members 50 and resistors 40. Each conducting member 50 may be made of conductive rubber which has elasticity, for example, and has a conical shape with its center as a vertex. The conducting members 50 are adhered to the inside of the top surface of the elastic areas 222a formed in the elastic body 222.

In addition, the resistors 40 may be provided on an internal board 204, for example, opposite the conducting members 50, so that the conducting members 50 come into contact with resistors 40 together with the pushing action of the control buttons 221. The conducting member 50 deforms, depending on the pushing force on the control button 221 (namely the contact pressure with the resistor 40), so as shown in FIGS. 10B and 10C, the surface area in contact with the resistor 40 varies depending on the pressure. To wit, when the pressing force on the control button 221 is weak, as shown in FIG. 8B, only the area near the conical tip of the conducting member 50 is in contact. As the pressing force on the control button 221 becomes stronger, the tip of the conducting member 50 deforms gradually so the surface area in contact expands.

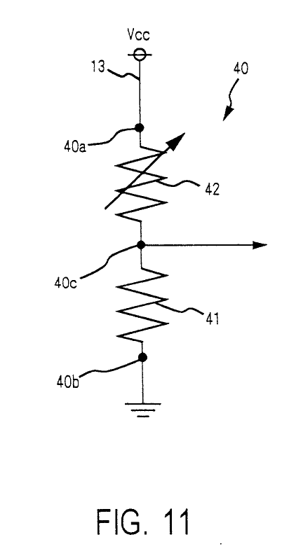

FIG. 11 is a diagram showing an equivalent circuit for a pressure-sensitive device consisting of a resistor 40 and conducting member 50. As shown in this diagram, the pressure-sensitive device is inserted in series in a power supply line 13, where the voltage V_{cc} is applied between the electrodes 40a and 40b. As shown in this diagram, the pressure-sensitive device is divided into a variable resistor 42 that has the relatively small resistance value of the conducting member 50, and a fixed resistor 41 that has the relatively large resistance value of the resistor 40. Among these, the portion of the variable resistor 42 is equivalent to the portion of resistance in the contact between the resistor 40 and the conducting member 50, so the resistance value of the pressure-sensitive device varies depending on the surface area of contact with the conducting member 50.

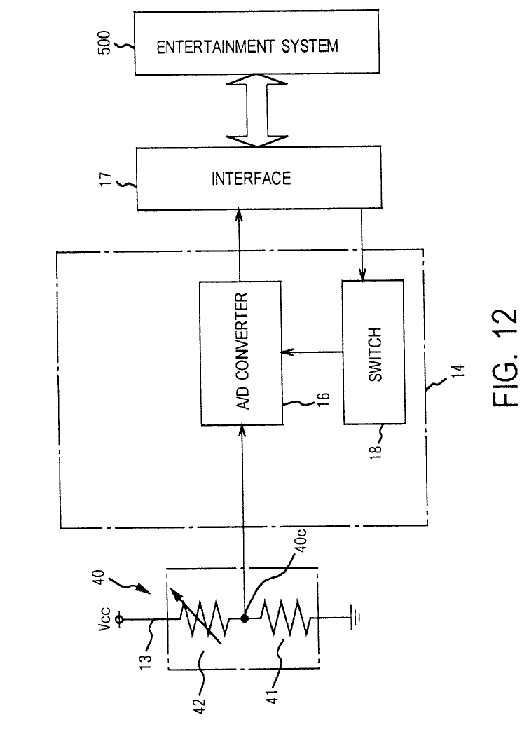

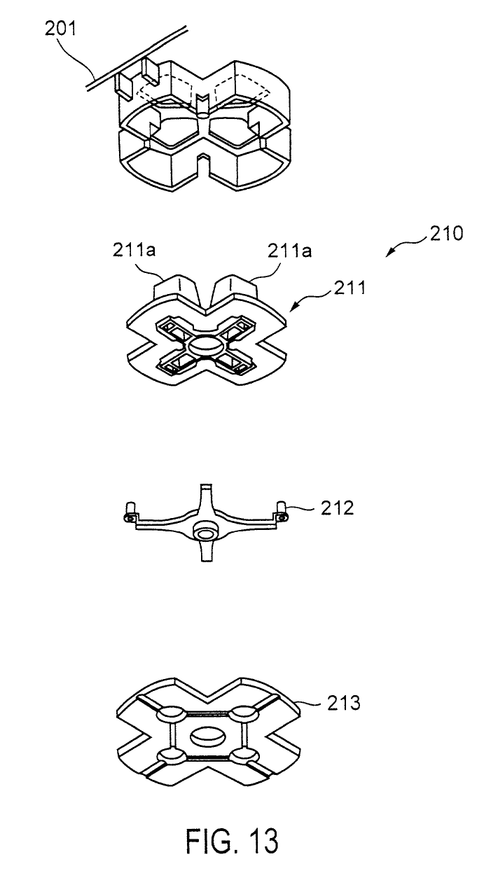

When the conducting member 50 comes into contact with the resistor 40, in the portion of contact, the conducting member 50 becomes a bridge instead of the resistor 40 and a current flows, so the resistance value becomes smaller in the portion of contact. Therefore, the greater the surface area of contact between the resistor 40 and conducting member 50, the lower the resistance value of the pressure-sensitive device becomes. In this manner, the entire pressure-sensitive device can be understood to be a variable resistor. It is noted that in FIGS. 10A-10C that show only the contact portion between the conducting member 50 and resistor 40 which forms the variable resistor 42 of FIG. 11, but the fixed resistor of FIG. 13 is omitted form FIG. 12.

In the preferred embodiment, an output terminal is provided near the boundary between variable resistor 42 and fixed resistor 41, namely near the intermediate point of the resistors 40, and thus a voltage stepped down from the applied voltage V_{cc} by the amount the variable resistance is extracted as an analog signal corresponding to the pushing pressure by the user on the control button 221.

First, since a voltage is applied to the resistor 40 when the power is turned on, even if the control button 221 is not pressed, a fixed analog signal (voltage) Vₘᵢₙ is provided as the output from the output terminal 40c. Next, even if the control button 221 is pressed, the resistance value of this resistor 40 does not change until the conducting member 50 contacts the resistor 40, so the output from the resistor 40 remains unchanged at Vₘᵢₙ. If the control button 221 is pushed further and the conducting member 50 comes into contact with the resistor 40, the surface area of contact between the conducting member 50 and the resistor 40 increases in response to the pushing pressure on the control button 221, and thus the resistance of the resistor 40 is reduced so the analog signal (voltage) output from the output terminal 40c of the resistor 40 increases. Furthermore, the analog signal (voltage) output form the output terminal 40c of the resistor 40 reaches the maximum Vₘₐₓ when the conducting member 50 is most deformed.

FIG. 12 is a block diagram showing the main parts of the controller 200.

An MPU 14 mounted on the internal board of the controller 200 is provided with a switch 18, an A/D converter 18 and two vibration generation systems. The analog signal (voltage) output from the output terminal 40c of the resistor 40 is provided as the input to the A/D converter 16 and is converted to a digital signal.

The digital signal output from the AID converter 16 is sent via an interface 17 provided upon the internal board of the controller 200 to the entertainment system 500 and the actions of game characters and the like are executed based on this digital signal.

Changes in the level of the analog signal output from the output terminal 40c of the resistor 40 correspond to changes in the pushing pressure received form the control button 221 (control element) as described above. Therefore, the digital signal outputted from the A/D converter 16 corresponds to the pushing pressure on the control button 221 (control element) from the user. If the actions of the game characters and the like are controlled based on the digital signal that has such a relationship with the pushing pressure from the user, it is possible to achieve smoother and more analog-like action than with control based on a binary digital signal based only on zeroes and ones.

The configuration is such that the switch 18 is controlled by a control signal sent from the entertainment system 500 based on a game program recorded on an optical disc 411. When a game program recorded on optical disc is executed by the entertainment system 500, depending on the content of the game program, a control signal is provided as output to specify whether the A/D converter 16 is to function as a means of providing output of a multi-valued analog signal, or as a means of providing a binary digital signal. Based on this control signal, the switch 18 is switched to select the function of the A/D converter 16.

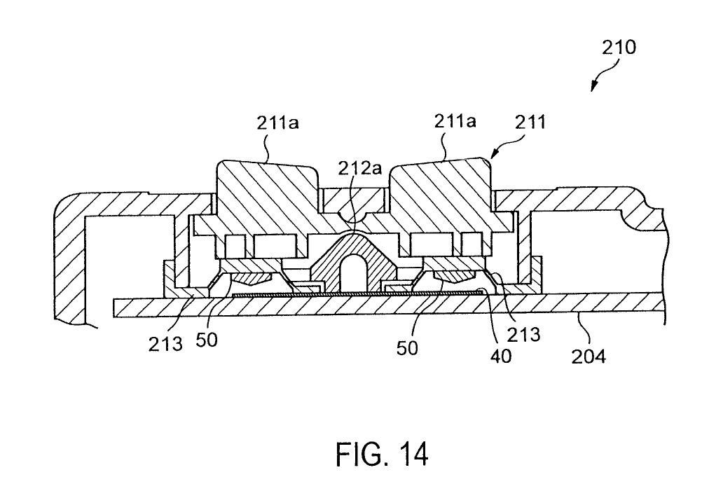

FIGS. 13 and 14 show an embodiment of the configuration of the first control part of the controller.

As shown in FIG. 13, the first control part 210 includes a cruciform control unit 211, a spacer 212 that positions this control unit 211, and an elastic body 213 that elastically supports the control unit 211. Moreover, as shown in FIG. 12, a conducting member 50 is attached to the rear surface of the elastic body 213, and the configuration is such that resistors 40 are disposed at the positions facing the individual control keys 211a (control elements) of the control unit 211 via the elastic body 213.

The overall structure of the first control part 210 has already been made public knowledge in the publication of unexamined Japanese patent application No. JP-A-H8-163672. The control unit 211 uses a hemispherical projection 212a formed in the center of the spacer 212 as a fulcrum, and the individual control keys 211a (control elements) are assembled such that they can push on the resistor 40 side (see FIG. 14).

Conducting members 50 are adhered to the inside of the top surface of the elastic body 213 in positions corresponding to the individual control keys 211a (control elements) of the cruciform control unit 211. In addition, the resistors 40 with a single structure are disposed such that they face the individual conducting members 50.

When the individual control keys 211a which are control elements are pushed, the pushing pressure acts via the elastic body 213 on the pressure-sensitive devices consisting of a conducting member 50 and resistor 40, so that its electrical resistance value varies depending on the magnitude of the pushing pressure.

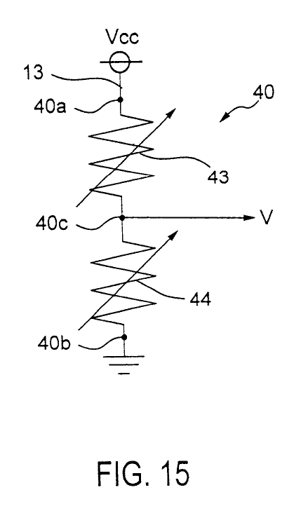

FIG. 15 is a diagram showing the circuit configuration of the resistor. As shown in this diagram, the resistor 40 is inserted in series in a power supply line 13, where a voltage is applied between the electrodes 40a and 40b. The resistance of this resistor 40 is illustrated schematically, as shown in this diagram; the resistor 40 is divided into first and second variable resistors 43 and 44. Among these, the portion of the first variable resistor 43 is in contact, respectively, with the conducting member 50 that moves together with the control key (up directional key) 211a for moving the character in the up direction, and with the conducting member 50 that moves together with the control key (left directional key) 211a for moving the character in the left direction, so its resistance value varies depending on the surface area in contact with these conducting members 50.

In addition, the portion of the second variable resistor 44 is in contact, respectively, with the conducting member 50 that moves together with the control key (down directional key) 211a for moving the character in the down direction, and with the conducting member 50 that moves together with the control key (right directional Key) 211a for moving the character in the right direction, so its resistance value varies depending on the surface area in contact with these conducting members 50.

Moreover, an output terminal 40c is provided intermediate between the variable resistors 43 and 44, and an analog signal corresponding to the pushing pressure on the individual control keys 211a (control elements) is providing as output from this output terminal 40c.

The output from the output terminal 40c can be calculated from the ratio of the split in resistance value of the first and second variable resistors 43 and 44. For example, if R1 is the resistance value of the first variable resistor 43, R2 is the resistance value of the second variable resistor 44 and V_{cc} is the power supply voltage, then the output voltage V appearing at the output terminal 40c can be expressed by the following equation.

V=V_{cc}×R2/(R1+R2)

Therefore, when the resistance value of the first variable resistor 43 decreases, the output voltage increases, but when the resistance value of the second variable resistor 44 decreases, the output voltage also decreases.

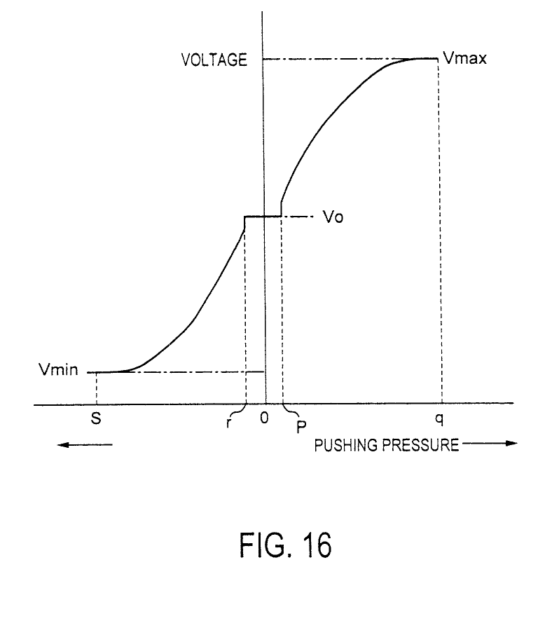

FIG. 16 is a graph showing the characteristic of the analog signal (voltage) outputted from the output terminal of the resistor.

First, since a voltage is applied to the resistor 40 when the power is turned on, even if the individual control keys 211a of the control unit 211 are not pressed, a fixed analog signal (voltage) V₀ is provided as output form the output terminal 40c (at position 0 in the graph).

Next, even if one of the individual control keys 221a is pressed, the resistance value of this resistor 40 does not change until the conducting member 50 contacts the resistor 40, and the output from the resistor 40 remains unchanged at V₀.

Furthermore, if the up-directional key or left-directional key is pushed until the conducting member 50 comes into contact with the first variable resistor 43 portion of the resistor 40 (at position p in the graph), thereafter the surfaced area of contact between the conducting member 50 and the first variable resistor 43 portion increases in response to the pushing pressure on the control key 221a (control elements), and thus the resistance of that portion is reduced so the analog signal (voltage) output from the output terminal 40c of the resistor 40 increases. Furthermore, the analog signal (voltage) output form the output terminal 40c of the resistor 40 reaches the maximum Vₘₐₓ when the conducting member 50 is most deformed (at position q in the graph).

On the other hand, if the down-directional key or right-directional key is pushed until the conducting member 50 comes into contact with the second variable resistor 44 portion of the resistor 40 (at position r in the graph), thereafter the surface area of contact between the conducting member 50 and the second variable resistor 44 portion increases in response to the pushing pressure on the control key 211a (control elements), and thus the resistance of that portion is reduced, and as a result, the analog signal (voltage) output from the output terminal 40c of the resistor 40 decreases. Furthermore, the analog signal (voltage) output form the output terminal 40c of the resistor 40 reaches the minimum Vₘᵢₙ when the conducting member 50 is most deformed (at position s in the graph).

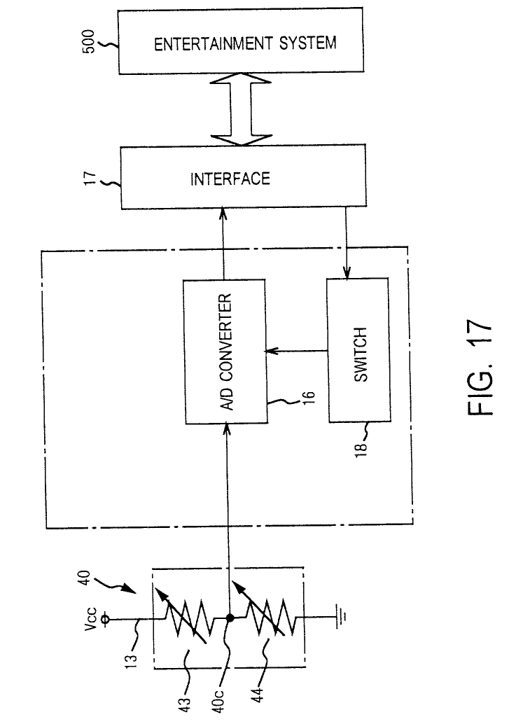

As shown in FIG. 17, the analog signal (voltage) output from the output terminal 40c of the resistor 40 is provided as input to an A/D converter 16 and converted to a digital signal. Note that the function of the A/D converter 16 is shown in FIG. 17 is as described previously based on FIG. 12, so a detailed description shall be omitted here.

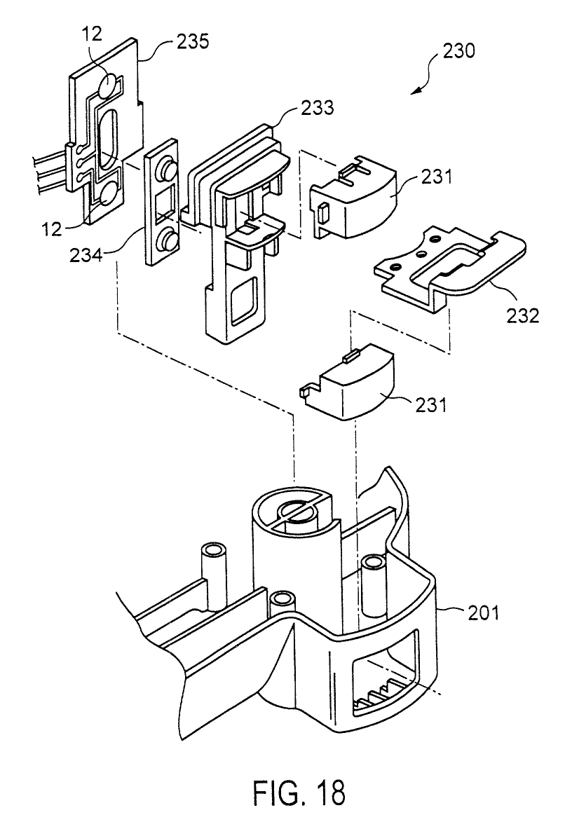

FIG. 18 is an exploded perspective view of the third control part of the controller.

The third control part 230 consists of two control buttons 231, a spacer 232 for positioning these control buttons 231 within the interior of the controller 200, a holder 233 that supports these control buttons 231, an elastic body 234 and an internal board 235, having a structure wherein resistors 40 are attached to appropriate locations upon the internal board 235 and conducting members 50 are attached to the rear surface of the elastic body 234.

The overall structure of the third control part 230 also already has been made public knowledge in the publication of unexamined Japanese patent application No. JPA-H8-163672, so a detailed description thereof will be omitted. The individual control buttons 231 can be pushed in while being guided by the spacer 232, the pushing pressure when pressed acts via the elastic body 234 on the pressure-sensitive device consisting of a conducting member 50 and resistor 40. The electrical resistance value of the pressure-sensitive device varies depending on the magnitude of the pushing pressure it receives.

It is noted that the fourth control part 240 has the same structure as that of the third control part 230 described above.

By means of the recording medium, computer, method of executing processes and method of selecting and executing processes according to the present invention, it is possible to make the pushing of a simple ON/OFF switch or the continuous pushing thereof as a user for an output representation an easier-to-use interface for users. Moreover, due to the present invention, commands are selected depending on the pushing time of the pressure-sensitive button, so it is possible to realize an entertainment system with a user interface that is improved in comparison to the repeated or continuous turning ON of a simple ON/OFF switch.

1. A recording medium upon which is recorded a computer-readable and executable program that performs processing by taking as instructions an output from a controller which has pressure-sensitive means, wherein
said software program performs processing based on instructions depending on a duration of pushing by a user of said controller.

2. The recording medium according to claim 1, said pushing includes at least hitting and pushing actions by a user.

3. A recording medium upon which is recorded a computer-readable and executable program that performs processing by taking as instructions an output from a controller which has pressure-sensitive means, wherein
said software program performs processing based on instructions depending on a magnitude of an output value of said controller.

4. The recording medium according to claim 3, characterized said output value depends on user's actions which include at least hitting and pushing actions.

5. A computer comprising: a controller which includes pressure-sensitive means;
means for determining a duration of pressure by a user on the computer, sensed by said pressure-sensitive means,
means for selecting and entering an instruction corresponding to said duration of pressure; and
means for executing a process based on said instruction thus entered.

6. A computer comprising: a controller which includes pressure-sensitive means;
means for determining a magnitude of pressure by a user on the computer, sensed by said pressure-sensitive means,
means for selecting and entering an instruction corresponding to said magnitude of pressure; and
means of executing a process based on said instruction thus entered.

7. A computer comprising: a controller which includes pressure-sensitive means;
means for determining a percent change between a pressure value sensed previously by said pressure-sensitive means and a current pressure value of pressure by a user on said computer;
means for selecting and entering an instruction corresponding to said percent change in the pressure value; and
means of executing a process based on said instruction thus entered.

8. A method of executing processes using a computer including a controller which has pressure-sensitive means, comprising:
a step of determining a duration of a pushing pressure by a user on said controller,
a step of selecting and entering an instruction corresponding to said duration of pressure, and
a step of executing a process based on said instruction thus entered.

9. A method of executing processes using a computer including a controller which has pressure-sensitive means, comprising:
a step of determining a magnitude of the pushing pressure by a user of said controller;
a step of selecting and entering an instruction corresponding to said magnitude of pressure; and
a step of executing a process based on said instruction thus entered.

10. A method of executing processes using a computer including a controller which has pressure-sensitive means, comprising:
a step of determining a percent change between a pushing pressure value of the controller sensed previously by said pressure-sensitive means and a current pressure value of pressure by a user on said controller;
a step of selecting and entering an instruction corresponding to said percent change in said pushing pressure; and
a step of executing a process based on said instruction thus entered.
